(19) United States
(12) Patent Application Publication
(10) Pub. No.: US 2016/0100612 A1
(43) Pub. Date: Apr. 14, 2016

(54) Process for Treating Vegetable Material with an Enzyme

(71) Applicant: Novozymes A/S, Bagsvaerd (DK)

(72) Inventors: Lisbeth Kalum, Bagsvaerd (DK); Hanne Vang Hendriksen, Bagsvaerd (DK)

(73) Assignee: Novozymes A/S, Bagsvaerd (DK)

(21) Appl. No.: 14/971,650

(22) Filed: Dec. 16, 2015

Related U.S. Application Data
(63) Continuation of application No. 14/700,446, filed on Apr. 30, 2015, now abandoned.
Application No. 14/700,446 is a continuation of application No. 14/482,519, filed on Sep. 10, 2014, now abandoned.
Application No. 14/482,519 is a continuation of application No. 13/526,928, filed on Jun. 19, 2012, now abandoned.
Application No. 13/526,928 is a continuation of application No. 12/057,608, filed on Mar. 28, 2008, now abandoned.
(60) Provisional application No. 60/909,083, filed on Mar. 30, 2007.

(30) Foreign Application Priority Data
Mar. 29, 2007 (EP) 07105190.8

(51) Int. Cl. A23B 5/00

(52) U.S. Cl. CPC A23L 1/025; A23L 1/034; A23L 1/217; A23L 1/0107; A23V 2002/00

(57) ABSTRACT

The enzymatic effect on an intracellular substrate present in vegetable cells with a membrane can be increased by pre-treating the vegetable material with a pulsed electric field.

### CROSS-REFERENCE TO RELATED APPLICATIONS

This application is a continuation of U.S. application Ser. No. 14/700,446 filed on Apr. 30, 2015 (pending), which is a continuation of U.S. Ser. No. 14/482,519 filed on Sep. 10, 2014 (now abandoned), which is a continuation of U.S. application Ser. No. 13/526,928 filed on Jun. 19, 2012 (now abandoned), which is a continuation of U.S. application Ser. No. 12/057,608 filed on Mar. 28, 2008 (now abandoned), which claims priority or the benefit under 35 U.S.C. 119 of European application no. 07105190.8 filed Mar. 29, 2007 and U.S. provisional application no. 60/909,083 filed Mar. 30, 2007, the contents of which are fully incorporated herein by reference.

### FIELD OF THE INVENTION

The present invention relates to a process for treating vegetable material with an enzyme.

### BACKGROUND OF THE INVENTION

Enzymes are sometimes used to treat vegetable material with intact cells where the substrate for the enzyme is present inside the cell membrane. One such example is enzymatic treatment of potato products.

It is known that acrylamide can be formed during deep frying of potatoes to make products such as potato chips and french-fried potatoes. It is known from WO 2004/026042, WO 2004/026043, WO 2004/030468, WO 2004/032648, and WO 2006/053563 that the acrylamide formation in such products may be reduced by a treatment with asparaginase or an oxidoreductase such as glucose oxidase to reduce the amount of asparagine or glucose in the potato product before the deep frying.

H. G. L. Coster, Biophysics Journal 5, 668-689 (1965) and E. Williams et al., Biophysics Journal, 8, 145-147 (1967) describe the possibility of using high intensity electric fields to permeabilize the cell membrane of vegetable materials.

WO 2006/121397 describes the use of electroporation at an electric field strength of 0.2-10 kV/cm for treating cellular potato material to produce holes (pores) in the cell membrane and make French fries, potato chips or potato crisps.

### SUMMARY OF THE INVENTION

The inventors have found that the enzymatic effect on an intracellular substrate present in vegetable cells with a membrane can be increased by pre-treating the vegetable material with a pulsed electric field.

Accordingly, the invention provides a process for treating vegetable material with an enzyme, comprising:

a) providing vegetable material comprising cells having a membrane and comprising an intracellular substrate for the enzyme,

b) treating the material with a pulsed electric field, and subsequently

c) treating the material with the enzyme.

### DETAILED DESCRIPTION OF THE INVENTION

### Vegetable Material

The invention is applicable to enzymatic treatment of vegetable material comprising cells which have a membrane and which comprise an intracellular substrate for the enzyme. As an example, the cells may comprise intracellular asparagine and/or an intracellular reducing sugar.

Thus, the invention is applicable to an enzymatic pre-treatment of tubers such as potato (tubers from Solanum tuberosum) with the aim of reducing the level of acrylamide in food products made by heating (e.g., frying) of the potatoes, such as potato chips or french fries. The enzyme may be an enzyme capable of reacting on asparagine or an oxidoreductase capable of oxidizing the reducing sugar. Typical conditions for the enzymatic treatment are pH 4.5-8.5 and 25-60° C. for 5-30 minutes.

Thus, one aspect of the invention provides a process, comprising the sequential steps of:

a) providing vegetable material comprising potato cells having a membrane,

b) treating the material with a pulsed electric field (PEF),

c) treating the material with an enzyme capable of reacting on asparagine or an oxidoreductase capable of oxidizing the reducing sugar, and

d) heating the material to make a food product.

The process typically comprises washing, peeling, and cutting (e.g., slicing) the potatoes. The process may further comprise parfrying, blanching, freezing and thawing, e.g., as described in WO 2006/053563. The food product may particularly be potato chips or French fries.

The enzyme treatment may be performed as described in the example below or in WO 2004/026042, WO 2004/026043, WO 2004/030468, WO 2004/032648, or WO 2006/053563. The treatment may be performed by incubating the tuber material in an aqueous enzyme solution. Alternatively, the tuber material may be sprayed with or immersed in such a solution, followed by incubation, e.g., during drying or transportation.

### Enzyme Capable of Reacting on Asparagine

The enzyme capable of reacting with asparagine may be an asparaginase (EC 3.5.1.1), e.g., derived from Aspergillus oryzae, Aspergillus nidulans, Aspergillus niger, Aspergillus fumigatus, Erwinia chrysanthemii, Saccharomyces cerevisiae, Candia utilis, Escherichia coli, Fusarium graminearum, or Penicillium citrinum, e.g., as described in WO 2004/032648 or WO 2004/030468, such as the amino acid sequence shown in SEQ ID NO: 2 of WO 2004/032648.

The asparaginase may be used at a dosage of 200 to 100,000 ASNU per kg of vegetable solids, particularly 1,000-40,000 ASNU/kg, or 2,000-20,000 ASNU/kg. 1 ASNU (asparaginase unit) is defined as the amount of enzyme needed to generate 1.0 micromole of ammonia per minute at 37° C., pH 7.0 and a substrate concentration of 10 mg/mL.

Oxidoreductase Capable of Reacting with a Reducing Sugar as a Substrate

The oxidoreductase may be an oxidase or a dehydrogenase capable of reacting with a reducing sugar as a substrate such as glucose or maltose.

The oxidase may be a glucose oxidase, a pyranose oxidase, a hexose oxidase, a galactose oxidase (EC 1.1.3.9) or a carbohydrate oxidase which has a higher activity on maltose than on glucose. The glucose oxidase (EC 1.1.3.4) may be derived from Aspergillus niger, e.g., having the amino acid sequence described in U.S. Pat. No. 5,094,951. The hexose oxidase (EC 1.1.3.5) may be derived from algal species such as Iridophycus flaccidum, Chondrus crispus and Euthora cristata. The pyranose oxidase may be derived from Basidiomycete fungi, Peniophora gigantean, Aphyllophorales, Phanerochaete chrysosporium, Polyporus pinsitus, Bierkandera adusta or Phlebiopsis gigantean. The carbohydrate oxidase which has a higher activity on maltose than on glucose may be derived from Microdochium or Acremonium, e.g., from M. nivale (U.S. Pat. No. 6,165,761), A. strictum, A. fusidioides or A. potronii.

The dehydrogenase may be glucose dehydrogenase (EC 1.1.1.47, EC 1.1.99.10), galactose dehydrogenase (EC 1.1.1.48), D-aldohexose dehydrogenase (EC 1.1.1.118, EC 1.1.1.119), cellobiose dehydrogenase (EC 1.1.5.1, e.g., from Humicola insolens), fructose dehydrogenase (EC 1.1.99.11, EC 1.1.1.124, EC 1.1.99.11), aldehyde dehydrogenase (EC 1.2.1.3, EC 1.2.1.4, EC 1.2.1.5). Another example is glucose-fructose oxidoreductase (EC 1.1.99.28).

The oxidoreductase is used in an amount which is effective to reduce the amount of acrylamide in the final product. For glucose oxidase, the amount may be in the range 50-20,000 (e.g., 100-10,000 or 1,000-5,000) GODU/kg dry matter in the raw material. One GODU is the amount of enzyme which forms 1 micromole of hydrogen peroxide per minute at 30° C., pH 5.6 (acetate buffer) with glucose 16.2 g/l (90 mM) as substrate using 20 min. incubation time. For other enzymes, the dosage may be found similarly by analyzing with the appropriate substrate.

### Pulsed Electric Field

The material with vegetable cells is treated with a pulsed electric field so as to create pores in the cell membranes, preferably resulting in an enhanced rate of mass transfer of intracellular substances. The electric field may have a field strength (voltage) above 10 kV/cm, above 20 kV/cm, or above 30 kV/cm, and preferably below 50 or below 40 kV/cm. The pulsed electric field may have a frequency of 10-200 pulses/min and duration of 0.5-5 minutes.

The electric field pulses may be applied in the form of exponential decaying, square-wave, oscillatory, bipolar, or instant reverse charges. The pulse width may be 2-50 micro-seconds. The electric field treatment may be performed continuously, e.g., as described in WO 2006/121397.

### EXAMPLES

### Example 1

### Evaluation of Pulsed Electric Field as Pretreatment for Potato Slices

### Procedure:

Bintje potatoes were peeled and sliced (1.4 mm). 400-450 ml tap water was added to 300 g potato slices and transferred to the treatment chamber (total volume 750 ml). Four different field strengths (0, 10, 20 and 35 kV) with 100 pulses over 2 min. were applied. After the PEF treatment, the potato slices and tap water were transferred to a beaker glass and incubated with or without asparaginase (31500 U/l) for 20 min at room temperature. Water samples and potato slices were frozen. The frozen potato slices (without thawing) were deep fried for 210 seconds in vegetable oil at 180° C.

Monosaccharide (glucose) in water samples was analyzed with a blood sugar device immediately after enzyme incubation. Amino acids were analyzed using HPLC. Texture was evaluated qualitatively after the PEF treatment. Acrylamide in the fried product was determined by HPLC after extraction, and the dry substance content was determined by drying at 105° C. for 40 hours.

The results are shown in the following table (bq=below quantification=0.013 mM; bd=below detection; enz=asparaginase; Asp=aspartic acid; Asn=asparagine):

| | | | Amino acid | | Amino | | | | Acrylamide | | |
|---|---|---|---|---|---|---|---|---|---|---|---|
| | | | (mM) | | acid (mM) | | | | (ppm) after | | |
| Sample | Glucose (mM) | | No Enz | | Enz | | DS after frying | | frying | | |
| treatment | No enz | enz | Asp | Asn | Asp | Asn | No enz | enz | No enz | enz | Texture |
| 0 kV | bq | bq | bq | bq | 0.04 | bd | 95.6 | 93.9 | 19054 | 4571 | Crisp |
| 10 kV | 5.9 | 8.0 | bq | 0.19 | 0.24 | bd | 94.9 | 95.0 | 18673 | 4795 | Slightly |
| | | | | | | | | | | | crisp |
| 20 kV | 6.9 | 7.4 | bq | 0.09 | 0.31 | bd | 92.6 | 94.8 | 9456 | 3864 | Soft |
| 35 kV | 8.0 | 7.3 | 0.03 | 0.23 | 0.28 | bd | 95.2 | 93.9 | 16354 | 2700 | Very soft |

Enhanced leaching of glucose was observed at field strength level above 10 kV. Tissue softening was found to increase with increasing field strength changing from crisp (no PEF) to very soft (35 kV). Acrylamide level was almost not affected by the PEF treatment alone. Asparaginase was found to reduce the overall level significantly. A synergistic effect was observed when combining asparaginase with high field strength, above 20 kV.

1-10. (canceled)

11. A process for treating vegetable material with an enzyme, comprising:
a) providing vegetable material comprising cells having a membrane and comprising an intracellular substrate for the enzyme,
b) treating the material with a pulsed electric field, and subsequently
c) treating the material with the enzyme.

12. The process of claim 11, wherein
a) the cells comprise intracellular asparagine and/or an intracellular reducing sugar,
b) the enzyme is an enzyme capable of reacting on asparagine or an oxidoreductase capable of oxidizing the reducing sugar, and
c) the process comprises heat treatment after the enzyme treatment.

13. The process of claim 12, wherein the enzyme is an asparaginase.

14. The process of claim 11, wherein the cells comprise intracellular glucose.

15. The process of claim 14, wherein the enzyme is glucose oxidase, hexose oxidase or pyranose oxidase.

16. The process of claim 11, wherein the vegetable material comprises pieces of tuber, particularly potato.

17. The process of claim 16, comprising the sequential steps of:
a) treating vegetable material comprising potato cells having a membrane with a pulsed electric field,
b) treating the material with an enzyme capable of reacting on asparagine or an oxidoreductase capable of oxidizing the reducing sugar, and
c) heating the material to make a food product.

18. The process claim 17, wherein the heating comprises frying, and the food product is potato chips or French fries.

19. The process of claim 11, wherein the pulsed electric field has a field strength above 20 kV/cm.

20. The process of claim 11, wherein the pulsed electric field has a field strength above 30 kV/cm.

21. The process of claim 11, wherein the pulsed electric field has a frequency of 10-200 pulses/min and duration of 0.5-5 minutes.
